(19) United States
(12) Patent Application Publication
(10) Pub. No.: US 2025/0366461 A1
(43) Pub. Date: Dec. 4, 2025

(54) Weed Control Device and Method

(71) Applicant: Bluevault Pty Ltd., Brisbane (AU)

(72) Inventor: John Bremhorst, Queensland (AU)

(21) Appl. No.: 18/875,443

(22) PCT Filed: Aug. 23, 2023
(86) PCT No.: PCT/AU2023/050808

§ 371 Date: Dec. 16, 2024

(30) Foreign Application Priority Data
Aug. 26, 2022 (AU) 2022902449

(51) Int. Cl. A01M 21/02; A01M 21/04

(52) U.S. Cl. CPC A01M 21/02; A01M 21/043

(57) ABSTRACT

The present invention relates to a weed control module. The module includes a first roller. A second roller is provided for locating adjacent the first roller to cause damage to weeds passing between the rollers and/or under the rollers. Advantageously, the weed control module may be used to achieve weed control by stressing and maiming the weeds and in doing so, using the weeds as sacrificial vegetation that, secondary to their control through death or maiming, sacrificially assist the growth of planted crops. Advantageously, the weed control module may achieve weed control without ploughing and without the application of herbicides.

### TECHNICAL FIELD

The present invention generally relates to a weed control device and method.

### BACKGROUND

The reference to any prior art in this specification is not, and should not be taken as an acknowledgement or any form of suggestion that the prior art forms part of the common general knowledge.

In agriculture, weed control may be undertaken to kill, maim, impede and prevent propagation of weeds, weed seeds and other unwanted vegetation (herein all referred to as “weeds”) in areas of productive growing fields, so as to optimise the yield of intentionally grown crops.

Weeds in crop farming are considered to be any vegetation that is not intentionally grown in a location in the field where it is intended to be. So, for example, aside from weed vegetation in the narrow sense, any crop plants that grow in furrows rather than in planted rows are also considered weeds.

A weed's underground root system can typically constitute ⅔ the size of the total size of a weed and supports an underground rhizosphere microbiome. The rhizosphere microbiome enhances the soil nutrients in both the crop rows and the furrows. The rhizosphere microbiome in the furrows is beneficial to crop growth and yield.

Further, a companion interrow crop or multi-species crop, planted in a furrow may be intentionally planted to be sacrificial or partially sacrificial to enhance the yield of the crop. Companion interrow crops increase crop yields by increasing diversity and removing monocrop culture. Weeds can be used sacrificially for similar purposes. Further, weeds may include crops grown in row, which are intended to be reprocessed into the soil rather than being harvested.

The preferred embodiment provides a weed control device.

### SUMMARY OF THE INVENTION

According to one aspect of the present invention, there is provided a weed control module including:
a first roller; and
a second roller for locating adjacent the first roller to cause damage to weeds passing between the rollers and/or under the rollers;
wherein the first roller includes a convex surface and the second roller includes a concave surface, the first and second rollers forming a complementary fit.

Advantageously, the weed control module may be used to achieve weed control by stressing and maiming the weeds and in doing so, using the weeds as sacrificial vegetation that, secondary to their control through death or maiming, sacrificially assist the growth of planted crops. Advantageously, the weed control module may achieve weed control without ploughing and without the application of herbicides.

The rollers may have a curved interface. The rollers may be configured to apply a vertical or pulling force to the weeds. The weed control module may include motor means for driving the rollers in opposite directions to draw the weeds between them. The motor means may include belts for driving other rollers. The rollers may be driven at different speeds. The rollers may compress the weeds. The rollers may be adjustable to adjustably control the degree of compression. Each roller may rotate about a roller axis extending at an acute angle from vertical. At least one of the rollers may include a resilient material (e.g. polyurethane). The weed control module may include adjustable side shifting means. The weed control module may include adjustable vertical shifting means.

At least one of the rollers may include a gripping surface for gripping the weeds and further to apply a distribution of localized points of high compression and/or laceration to the weeds. At least one of the rollers may include a ribbed, grooved or corrugated surface. At least one of the rollers may include a heater for applying heat to the weeds. At least one of the rollers may include one or more air passages through which light, pneumatic air, gas and chemicals can be supplied to the weeds. The air passages may form a labyrinth. The air may be heated or cooled, or contain thermally cooling gases or chemicals. At least one of the rollers may include slots. The module may include a cleaner for cleaning the slots. The slots may include deep slots and shallow slots. At least one of the rollers may include helical formations, whether depressed or protruding. At least one of the rollers may include weed contact picks on the underside face of the roller adjacent to the soil surface. The picks may have aerofoil qualities to cause enhanced circulation of air, gas and chemical distributed from the labyrinth.

The weed control module may further include guard means for guarding at least one of the rollers. The guard means may include a sheath. The bases of the rollers may be scalloped.

Each module may include one or more mounting brackets. Each module may include spindles extending from the rollers and through the mounting brackets.

The module may further include guides for guiding weeds between the rollers. The module may include a reflector for reflecting light. The modules may include a horizontal ground support roller. The modules may include mechanical or electrical sensors that detect the height between ground features and the module.

According to another aspect of the present invention, there is provided a modular weed control device including one or more of the modules. The modules may be arranged in sets, with each set preferably being located in register with a respective furrow and/or between adjacent crop rows. Each set may include a quartet of modules. The quartet may be symmetrically arranged. The quartet may include a pair of distal forward modules and a pair of proximal rearward modules. The modules may be arranged using a variety of configurations of roller pairs consisting of a variety of numbers of rollers.

The weed control device may include a one or more light mounting frames to which lights may be mounted. The light mounting frames may be located adjacent respective sets. The light mounting frames may be height adjustable. The weed control device may include a frame to which the modules are mounted. The device may further include an electrical power source for powering the module. The device may include a terrain following mechanism which automatically adjusts the height of the rollers as the weed control device passes over uneven terrain so that the distance between the rollers and terrain remains constant.

The device may further include a stressor applicator for applying a stressor to the weeds. The stressor may include any one or more of a mechanical, light, thermal and pneumatic stressor.

The stressor applicator may include a light source for applying light. The light may include ultra-violet (UV) light. Even more preferably, the UV light is UV-C light. The light source may be elongate or discrete and focussed.

According to another aspect of the present invention, there is provided a weed control method including:
passing weeds between a first roller and a second roller located adjacent to the first roller to cause damage to the weeds;
wherein the first roller includes a convex surface and the second roller includes a concave surface, the first and second rollers forming a complementary fit.

The method may further involve applying a stressor to the weed. The step of applying may involve cyclically applying the stressor to the weed. The cyclical application period may be between 6-to-12 hours.

The method may involve transporting the rollers at the same speed as a conventional plough or sprayer. The method may involve transporting the rollers at about 5 m/s. Alternatively, the method may involve transporting the rollers slower or faster than 5 m/s.

The method may be performed prior to planting a crop. The method may be performed prior to harvesting a crop.

The method may involve leaving the damaged weed in the ground to facilitate growth of a crop.

According to another aspect of the present disclosure, there is provided a weed control method including:
applying at least one stressor to weeds, the stressor including any one or more of a mechanical, light, thermal and pneumatic stressor.

According to another aspect of the present disclosure, there is provided a weed control module including:
a stressor applicator for applying at least one stressor to weeds, the stressor including any one or more of a mechanical, light, thermal and pneumatic stressor.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic side perspective view of a weed control module in accordance with an embodiment of the present invention;

FIG. 2 is a front view of rollers of the weed control module of FIG. 1;

FIG. 3 is a lower side perspective view of the module of FIG. 1;

FIG. 4 is an upper front perspective view of a modular weed control device including a plurality of the modules of FIG. 1;

FIG. 5 is an upper front perspective view of a set of weed control modules of the device of FIG. 4, for a single furrow;

FIG. 6 is an upper front perspective view of a set of weed control modules for a single furrow and in accordance with another embodiment;

FIG. 7 is a front view of rollers of the weed control module of FIG. 1 showing surface grooving;

FIG. 8 is a front lower perspective view of a weed control device with scalloped rollers in accordance with another embodiment; and

FIG. 9 is a front upper perspective view of the weed control device of FIG. 8.

### DETAILED DESCRIPTION OF PREFERRED EMBODIMENTS

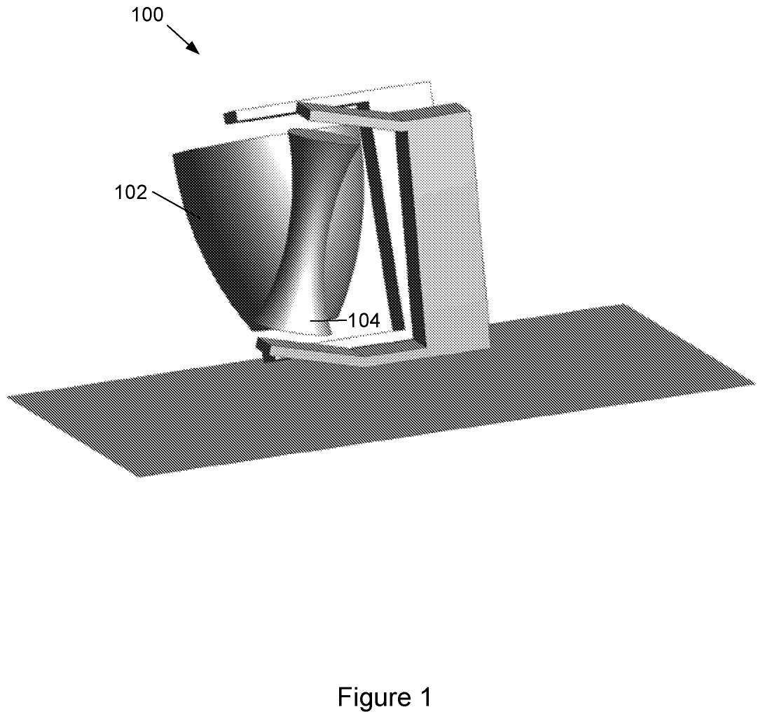

According to an embodiment of the present invention, there is provided a weed control module 100 as schematically shown in FIG. 1. The module 100 includes a larger convex (i.e. first) roller 102. A smaller concave (i.e. second) roller 104 is located adjacent the convex roller 102 to cause damage to weeds passing between the rollers 102, 104. Each roller 102, 104 rotates about a skewed roller axis extending at an acute angle from vertical.

Advantageously, the weed control module 100 can be used to achieve weed control by stressing and maiming the weeds and in doing so, using the weeds as sacrificial vegetation that, secondary to their control through death or maiming, sacrificially assists the growth of planted crops. Advantageously, the weed control module 100 can achieve weed control without ploughing and without the application of herbicides. Additionally, the module 100 further includes at least one stressor applicator for applying at least one stressor to the weeds. As described below, the stressor includes any one or more of a mechanical, light, thermal, chemical and pneumatic stressor.

The pair of rollers 102, 104 are designed to stress and strain the weeds mechanically in 3 dimensions, (all 3 axes x, y and z). Where a weed remains in ground, it either lives on sacrificially or dies, rots and is decomposed back into the soil as nutrition. This desirable effect is achieved by a variety of mechanisms designed into the rollers 102, 104 and associated equipment as explained below.

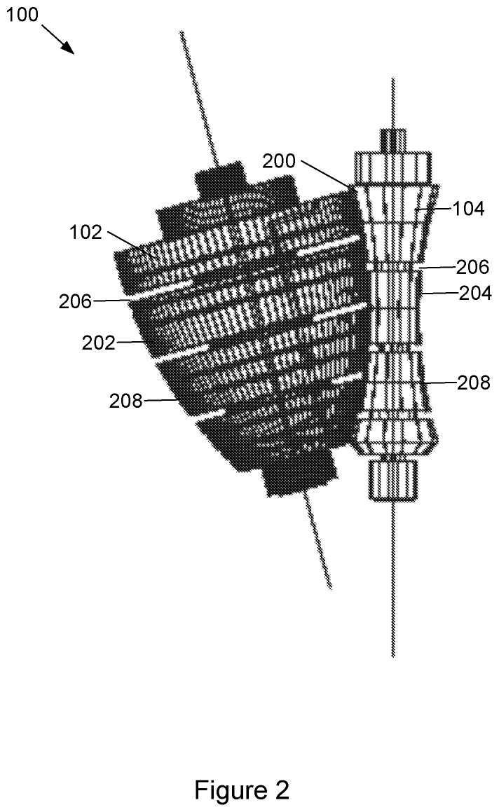

As can best be seen in FIG. 2, the rollers 102, 104 have a curved engagement interface 200, with the convex roller 102 having a lateral convex engagement surface 202 and the concave roller 104 include a lateral concave engagement surface 204. Accordingly, the rollers 102, 104 form a complementary fit. The rollers 102, 104 compress the weeds, and are adjustable to adjustably control the degree of compression. Direct compression and/or laceration at the roller interface 200 delivers a lateral crushing action to the weed. The crushing compression crushes the structure and transport vessels within the weed. The degree of compression and laceration is variable and controlled by sprung roller arms or other like adjustment mechanism.

The rollers 102, 104 define concentric deep slots 206 and shallow slots 208. The deep slots 206 enable UV light to permeate directly to the roller interface 200 where the damage is manifesting (and weed is thinnest and internal structure most exposed).

The shallow slots 208 facilitate the distribution of pneumatics at the roller interface 200 and are charged by an internal labyrinth of air passages at the interface 200.

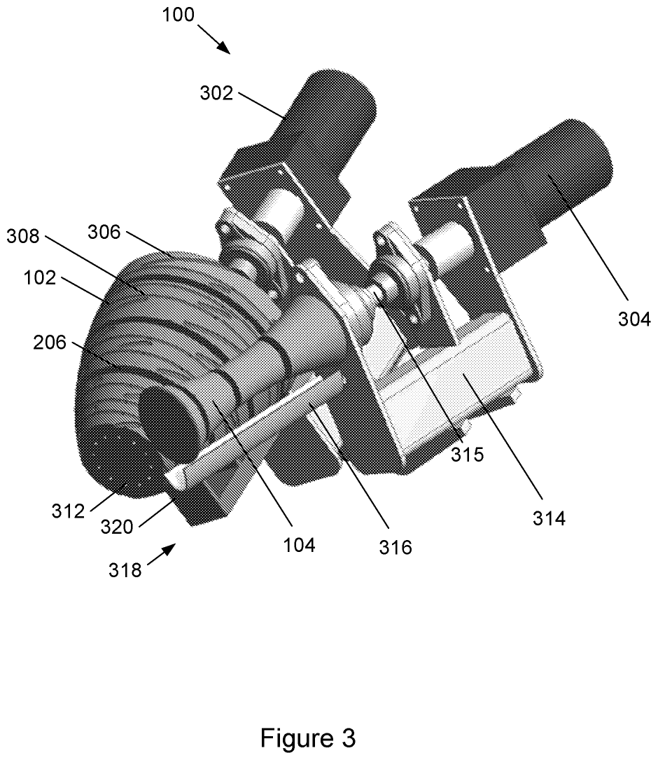

Turning to FIG. 3, the weed control module 100 includes motors 302, 304 for driving respective rollers 102, 104 in opposite directions to draw the weeds between them. The rollers 102, 104 are driven at different speeds which result in a tensile (pulling) damage to the weed in the each axis.

The convex roller 102 includes helical formations 306, whether depressed or protruding from the convex surface 202. The curved interface 200 between the pair of rollers 102, 104 and the surface helix 306 result in tensile (pulling) and laceration damage to the weeds in the vertical axis (as the weed is fixed in the ground by its roots). In one embodiment, the helical scrolls 306 are directionally positioned to scroll upward and inward towards the interface 200 of the pair of rollers 102, 104 (with each roller 102, 104 having an opposing scroll 306). The scrolls 306 may be either below the roller surface 202 or proud of the roller surface 202. They are in the order of 5 mm wide. The purpose of the scrolls 306 is to direct the weeds upwards along the interface 200 thereby applying greater vertical or pulling force to the weed.

One or more of the rollers 102, 104 are manufactured out of a flexible or resilient substance, such as polyurethane, and the two rollers 102, 104 interact at the interface 200 such that the convex roller 102 applies an additional vertical axial force to the weeds.

Roller texture and hardness of the surfaces 202, 204 can be varied to provide for different levels of ‘grip’ and/or laceration on different species of weeds. A typical texture is a 1 mm high dome shape, 1 mm in diameter and height per 5 square mm. For example, polyurethane rollers 102, 104 of 70 Duro hardness with a surface texture of 1 mm half spheres provides intractable friction to draw vegetation through the rollers 102, 104 and to compress it and/or lacerate it. Notwithstanding this, steel rollers can also be applied with effective surface textures. The textures will vary depending on effectiveness in any particular application. The textures may be different on each roller 102, 104 to suit an application.

Grooves, for example 308, may be employed as circumferential with or without heating strips on one or both of the rollers 102, 104, creating temperatures in the order of 100 to 250 degrees Celsius, apply additional heat stress to the weeds. Current is applied to the heating strips 308 of the rollers 102, 104 via an electrical slip ring on top of the roller shafts.

Pneumatic labyrinth air flow occurs through one or both of the rollers 102, 104. Pneumatic air pressure at the crushing interface 200 enhances physical macro and micro tearing of the weed structure and weed cells. The pneumatic pressure adds to vertical horizontal and shear forces applied to the weeds at the roller interface 200. The pneumatic labyrinth or air passages 312 is extended through to the underside of the convex roller 102 so the ground can be dosed with an agent (e.g. gas, chemical, steam, ozone etc) if necessary. Optional thermal, gas and chemical dosing of the pneumatic air flow (in the order of 50 to >250 degrees Celsius) or injecting chemicals, such as ozone into the airflow multiplies the stress effect on the weed thereby permeating damage inside the weed structure and cells. The stressors negatively affect the internal chemical and hormonal processes within weeds.

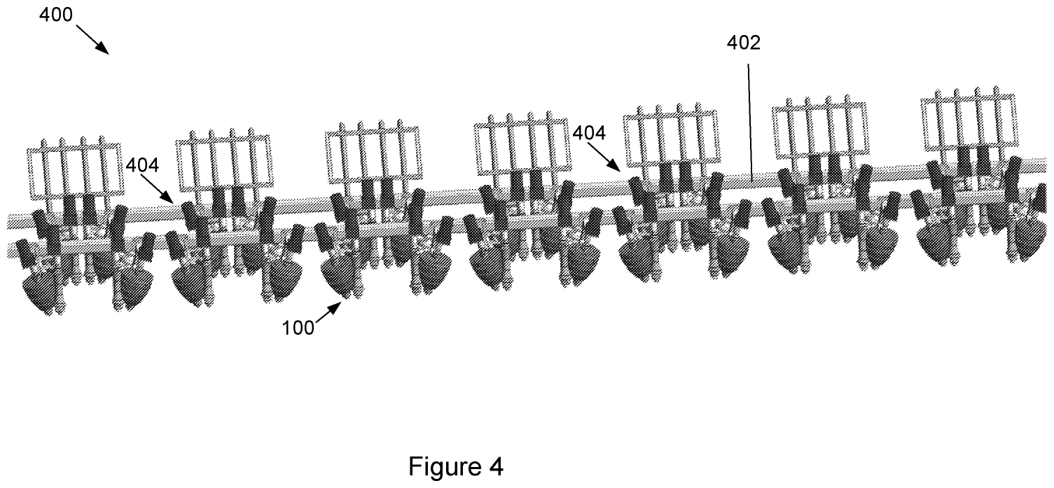

The module 100 includes two sprung mounting brackets 314 to which respective rollers 102, 104 are rotationally mounted. The module 100 includes spindles 315 extending from the rollers 102, 104 and through the mounting brackets 314 to the motors 302, 304. The mounting brackets 314 do not obstruct the base of the cantilevered rollers 102, 104, although may be coupled to the bases in other embodiments (e.g. as shown in FIG. 4).

The module 100 also includes a curved reflector 316 for reflecting UV light. The light reflector 316 irradiates weeds at the roller interface 200, and out through the deep slots 206 when UV is generated therein, and extends down beyond the base of the rollers 102, 104 to more fully irradiate the weeds on the ground under the rollers 102, 104. A similar effect can optionally be achieved with directional focused UV lighting.

The module 100 also includes a cleaner 318 extending down from a bracket 314 and for cleaning the deep slots 206. The cleaner 318 includes a frame at the rear of the convex roller 102 with horizontal slot cleaning fingers 320 extending into the deep slots 206.

As shown in FIG. 4, there is provided a modular weed control device 400 including a plurality of the modules 100. The modules 100 are arranged along and mounted to an elongate frame 402 in sets 404, with each set 404 being located in register with a respective furrow and/or between adjacent crop rows.

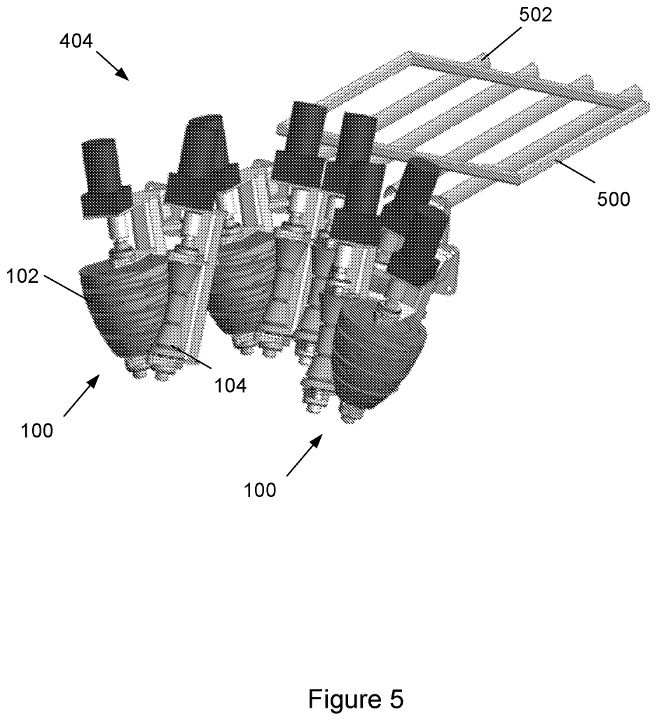

As can best be seen in FIG. 5, each set 404 includes a quartet of modules 100. Each quartet is symmetrically arranged, and includes a pair of distal forward modules 100 and a pair of proximal rearward modules 100 thereby forming a U-shape or mouth into which the weeds are fed.

The weed control device 400 includes light mounting frames 500, located adjacent respective sets 404, to which elongate lights 502 are mounted. The lights apply ultra-violet UV-C light to the damaged weeds passed through the rollers 102, 104. Application of ultraviolet light by fluorescent tube bulbs in the form of common UV-C doses causes micro damage to the structure of the weed and its cells and induces a stress response release of defensive chemicals, hormones, photosynthetic apparatus and increases photooxidative stresses. The UV power applied may vary depending on the application. The doses administered are considered low in power.

A weed control method involves passing weeds between the adjacent rollers 102, 104 to cause damage to the weeds. Additionally, the method involves cyclically applying a stressor to the weed. The cyclical application period may be between a 6-to-12 hours. The damaged weed is left in the ground to facilitate growth of a crop, and the method can be performed at any time, for example prior to planting or harvesting the crop.

The method involves transporting the rollers 102, 104 at the same speed as a plough or sprayer moving along the crop rows, namely at about 5 m/s. The weed control device 400 in the form of a drawn implement is towed over a field as a plough would be in a First Pass.

Within 6 hrs, the implement either with or without the rollers 102, 104 activated, is towed over the field in a Second Pass (i.e., typically, only the UV lights would be utilised for the second pass).

The UV-C dose is controlled by the dwell time of exposure (irradiation), proximity between the bulb 502 and the weeds and irradiance power of the bulb 502. Factors such as the density of weeds, type of weeds, mechanical damage of weeds determine how many passes are required. Other factors include the dose of UV light, the configuration of the device 400 during each pass affect the number of passes necessary.

Scientific research papers have identified the time critical nature of plant/weed internal repair in response to external stressors such as thermal and light stress. The invention is applied by a first pass, generally followed by a second pass within 6 hours of the first pass. A third pass may be made within 12 hours of the first pass. There is no restriction to the number of passes that may be made. The device 400 permits the rollers 102, 104 to be disengaged such that they may be actuated only for the first pass, further passes being with ultraviolet lighting exclusively from the lights 502. A weed's physiological repair window is in the order of 6-12 hours from initial damage, hence two to four passes within 6 to 12 hours are typical depending on the application. Prevention of internal repair of the weed within about 6 hours and up to 12 hours results in the induced stressors causing mortality or maiming of the weed.

The weed control device 400 can be used to control the level of harm exacted on weeds so as to:
terminate the weed if desired; or alternatively
apply controlled stress to weeds via the invention so as:
   a. to minimise the volume of moisture consumed by weeds;
   b. to minimise the nutrients absorbed by weeds;
   c. to permit weeds and their root system to remain in situ, maimed and barely surviving, so as to:
      provide shade to the ground under weed leaves;
      permit their root systems to remain alive, albeit retarded, so as to:
      contain the soil occupied by the weeds thereby reducing wind and water erosion;
         enhance the quality of soil in furrows for the benefit of crops;
         promote root microbiome (or rhizosphere microbiome) and soil microorganism proliferation in the soil generally and in furrows;
         promote and build crop root mass;
         promote and build overall soil nutrient and quality;
         act as sacrificial companion plants to enhance the growth of crop;
         reduce the probability of any other weed taking its position in the soil; and
      use their energy to enhance the crop.

The weed control device 400 provides an alternative to and/or completely replace existing “till” methods of weed control (ploughing, and ground working) and “no till” methods of weed control (spraying ground/crops with herbicide).

The weed control device 400 provides an alternative means of weed control for “till” farming such that weed control can be undertaken without ploughing which results in detrimental disturbance to underlying soil.

The weed control device 400 provides an alternative means of weed control for “no till” farming such that weed control can be undertaken without the application of herbicides which result in detrimental disturbance to underlying soil and its microbiology. The device 400 has the further effect of reducing the water required for crop production because herbicide is mixed with large quantities of water to facilitate herbicide spraying.

The principal application is broad acre farming however the weed control device 400 is scalable and applicable to every size and type of agricultural growing operation that needs to control weed growth.

The weed control device 400 and associated method apply mechanical energy, thermal energy, chemical compounds and light energy or combinations of them, as dosed stressors in order to cause controlled trauma to weeds and thereby inducing internal stresses and change of state in weed structures and soil. A proportion of weeds are extracted from the ground as the device 400 passes through them, thus further promoting green mulching.

The weed control can be applied anytime, typically, during the period preceding crop planting, during crop growth until such time the crop foliage is sufficient to block light from the furrow lines in between the growing crop rows. Additionally, there is an application for the weed control prior to harvesting by combine harvester so as to cause trauma to any remnant weeds/weed seeds prior to harvest.

The light applied is typically in the form of common ultraviolet range (generally UV-C, 254 nm) to the weed. Ultraviolet light has the advantage that is only affects the surface on which it shines on. There is no penetration of UV light deeper than the surface layer. The underground microbiome is not penetrated or harmed by UV light. Other wavelengths of light may be applied.

The biological objective of treating the weeds with the weed control device 400 is firstly, to cause structural damage which induces defensive molecular responses to that damage within the weed. The application of UV light to the weeds in their damaged condition then further stimulates molecular defensive mechanisms within the weed. Both the physical damage and the application of UV light stimulates the weeds defensive molecular mechanisms. Varying and controlling the dose of physical damage and UV damage causes desired death or maiming of weeds. The double or triple application of UV light within a 6-hour period (some scientific papers suggest 12 hours) causes overstimulation of defensive molecule production. Weeds are able to produce limited amounts of defensive molecules within a 6-hour period. By overloading weeds with stimulation resulting from damage, the capacity of the weed to restore the damage can be exceeded. Studies suggest that when weeds are overloaded beyond molecular restoration limits, they are unable to survive. By controlling the dose of the damage inflicted on a weed, it can be either killed or sacrificially maimed to a determinable degree. Testing undertaken by the author has confirmed the results of stress damage infliction on weeds to provide repeatable outcomes.

The causative processes for the damage are the combination of physical structural damage to internal transport routes, molecular defence pathways, transcription factors, photosynthesis capability destruction, chemical alteration and hormone alteration.

Advantageously, the weed control device 400 does not use mutagenic or high radioactive energy transfers or incineration. The weed control device 400 imparts the optimal trauma to a weed without necessarily decapitating it or pulling it from the ground, although that may happen. If the weed is sufficiently pulled out of the ground to cause it to die, it will decompose in situ and provide nutrition to the soil. The weed control device 400 is able to terminate or control weed growth for relatively low cost and relatively low power compared to existing methods and do so without the use of significant volumes of toxic herbicides.

The use of herbicides in weed control has resulted in weeds becoming herbicide resistant. Herbicide resistance results in fields being cropped with constraints that would not otherwise exist. For example, a crop may be planted and sprayed with one particular herbicide to control weeds for 1 or 2 years consecutively, however the field may not then be planted with the same crop because the remnant weeds in the field would otherwise be resistance to herbicide use. Herbicide use and weed resistance to herbicide causes crop field to have constraints placed on the crops that may be planted based on the resistance of weeds to herbicide. The weed control device 400 overcomes this problem.

The advantages of the weed control device 400 are:
lower cost farming is achievable due to the use of smaller, lighter, lower cost equipment required; lower operating costs; reduced number of costly inputs—e.g., herbicide, diesel, exhaust additive;
elimination of the requirement for “till” operations to plough the soil for weed control, thereby enhancing the soil condition and yield;
elimination of or the use of very substantially lower volumes of chemical herbicides, which overcomes:
weed herbicide resistance;
productivity constraints caused by weed herbicide resistance that affects productive crop field use year on year;
eliminates the harmful side effects of herbicide on soil condition and microbiology;
eliminates the harmful side effects of herbicide on waterways;
   reduced soil compaction and hence increased yield through the use of lighter equipment;
increased sequestration of carbon in soil; and
   higher crop yields through the use of weeds as sacrificial soil nutrient and by enhancing soil microbiology.

The advantages of the weed control device 400 can be expanded on by considering the inverse of the problems affecting existing methods and prior art.

Till methods require:
large high-power, high-cost tractors to draw ploughs. The larger tractor capital costs are in the order of $750 k.
high power tractors are in order of over 600 hp/400 kW.
high power tractors require large volumes of fuel and exhaust additive to operate.

These are expensive farm cost inputs. In the case of exhaust additive the product has been in short supply due to supply chain issues arising from the pandemic.
large ploughs are high-cost and high maintenance. Capital costs $150k to $250k.
conventional large-scale chisel ploughs used to control weeds require large tractor haulage powers (and hence large volumes of diesel to draw them) in the order of 15 kW/m of plough width (approx. eq. to 1 row) and are subject to high wear rates requiring ongoing maintenance.
inflationary pressures applying the above are making some farming operations unviable.
the use of lighter equipment results in less compaction of the productive soil because heavy equipment otherwise causes soil compaction as it passes adjacent to the production growing areas of paddocks.
soil to be turned, thus reducing the amount of carbon that may be sequestered.

In contrast to the above, the weed control device 400 requires magnitudes lower power (in the order of 1500 W/m contingent on application) and permits the use of small tractors or other small machines to draw the invention to prevent/main/control weeds.

Existing No-Till methods:
require the spraying of herbicide to control weeds. The cost of herbicide is expensive and subject to inflationary pressures.
the spraying of herbicide results in weeds becoming herbicide resistant (the herbicide is no longer effective).
herbicide resistance requires larger and larger volumes at increasing cost to be applied to control weeds with diminishing effect and increasing cost.

In contrast to the above, no herbicide is necessarily required thereby alleviating herbicide resistance issues and costs issues. No toxic by-product is produced via the process.

Known prior art concerns weed control in combine harvesters. Combine harvesters are used to harvest crops. They separate the crop into the commercial portion and discard the remnant portion back onto the field. When a combine harvester discards the remnant portion, it actively spreads the remnant material over the field. In doing so, it coincidentally spread weed seed thereby promoting weed growth and exacerbating the problem that weeds have become herbicide resistant. The prior art of controlling weeds within combine harvesters may be used in combination with the weed control device 400, however, the use of the weed control device 400 prior to harvesting (i) prevents weeds being present; (ii) reduces the presence of weed seeds; and (iii) potentially makes the below prior art obsolete by removing the need to treat weed seeds in combine harvesters.

A person skilled in the art will appreciate that many embodiments and variations can be made without departing from the ambit of the present invention.

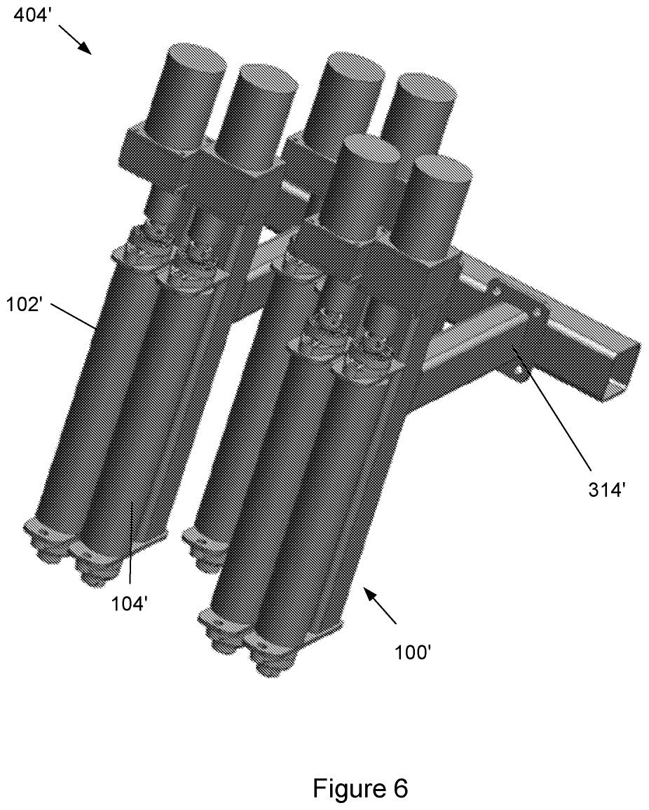

FIG. 6 shows another embodiment where the rollers 102′, 104′ of each set 404′ are cylindrical.

Sheaths (not shown) may extend around each roller 102, 104 to guard the rotating rollers 102, 104 and maintain some pneumatic pressure except at the vicinity of the interface 200. The module 100 can further include wheel guides for guiding weeds between the rollers 102, 104.

The module 100 further includes an electrical power source for powering the active components of the module 100. A source of forced or pneumatic air, and an air heating, cooling and chemical injection source optionally each form part of an embodiment of the invention.

The width and number of roller/UV light sets is scalable to any commercially desirable number of rows and to suit the UV dose. The detail depicted in FIG. 4 is repeated in any number of arrays to suit the particular application.

A Terrain Following mechanism can optionally be built into the weed control device 400, controlled either by a mechanical ground follower or by a sensor/computer control system with PID feedback. The weed control device 400 otherwise follows the trajectory set by the implement it is mounted to. The Terrain Following mechanism automatically adjusts the height of the rollers 102, 104 as the weed control device 400 passes over uneven terrain so that the distance between the rollers 102, 104 and terrain remains constant.

The rollers 102, 104 can be constructed of hybrid materials possessing a variety of mechanical engineering properties to be achieved, such as combination steel, polyurethane, glass, carbon fibre, resin, foam or a combination to permit different light sources to contact the crushing interfaces. The shafts 315 and rollers 102, 104 can be hollow or solid or a combination of each. The rollers 102, 104 are scalable, as is the profile of the interface 200 between them. The interface 200 may be linear (FIG. 6) or some other profile.

The rollers 102, 104 may be mounted on various different shaft configurations, for example, live shafts with bearings at either end as per FIGS. 4 to 6, or dead shaft where the rollers rotate on a static shaft. The bearings may be present at the upper end only, as per FIG. 3, so as to provide for a cantilevered shaft with unimpeded access to the ground.

One or both of the rollers 102, 104 in a roller pair may be fitted with an additional degree of motion such that for example the convex roller 102 is fitted with a gimble to permit it to rotate up/down relative to the interface 200 with the concave roller 104.

Skewed axis roller sets offer an interface cross-shearing of weeds.

Forward tiltable rollers and modified roller ground engagement permit the pairs of rollers 102, 104 to engage the ground surface at their leading edge when necessary and to engage with surface borne weeds.

The helical scrolls 306 on the rollers 102, 104 may be either below the roller surface or proud of the roller surface or not present at all depending on application.

Glass segments may be employed within the rollers 102, 104, suited to UV light transmission and conforming to the profile of the rollers 102, 104, to permit the UV light to permeate directly to the roller interface 200 where weed damage is manifesting (and weed is thinnest and internal structure most exposed). There may be a disadvantage in employing UV transmission glass however because it reduces the intensity of UV irradiance by approximately 5% through internal inefficiencies.

The motor/gearbox units 304 can be substituted with other conventional drive technologies: —pinion/chains, pulleys, belts, gears, chains, shafts etc, variable frequency electric drives, hydraulic motors, pneumatic motors. There is no restriction on the drive method and commercial considerations may guide the selection of the drive mechanism.

Currently, High Output UV-C fluorescent bulbs 502 are preferred. Alternatives including UV LED lights are becoming less costly and of higher power. UV lasers are becoming less costly and of higher power. Further, UVA, UVB or infrared light sources may have application depending on developments. A UV laser can be directed into the slots 206 in the rollers 102, 104 so as to cause damage to the weed at the location where it is most mechanically damaged and in a compressed “opened” state.

The dose and intensity of UV (and any other range of light) administered may vary on application, type of weed species being treated, density of weeds and speed of the device 400 relative to the ground.

The rollers 102, 104 currently have differential rotational speeds but they may be applied with identical rotational speeds. The roller speeds may vary and/or be computer controlled depending on application, type of weed species being treated, density of weeds and/or speed of the invention relative to the ground.

Picks on the underside of the rollers may operate in close proximity to ground bourn weeds, causing rotational damage to weeds that are lower than the rollers. The picks can be assisted by the turbulence of pneumatic chemical or gaseous stressors that are applied via the pneumatic labyrinth. Scalloped profiles can optionally be manufactured into the base of the rollers direct weeds to the convergence point of the rollers.

The sprung roller arms or brackets 314 may be comprised of simple mechanical springs and buffer or they may be automated with actuators or other commonly available actuation means.

Constant pressure or pulsed or combinations of pneumatic air can be used in the rollers 102, 104. Pulsed air generates more damage generally. Commercially, available pneumatic pulse valves can be directly applicable to the design. The air can be heated or cooled to an optimal temperature. The pneumatics are not limited to air. It is possible to apply any gas that results in increased stress to particular weeds.

It will be possible to add an intelligent feature to the weed control device 400 to direct higher or lower doses of UV light to areas where more weeds are detected. This may be achieved by adding sensors to the motors 304 to detect the amount of current drawn by the individual pairs of rollers 102, 104 or by using conventional weed sensing vision systems.

Temperatures applied through temperature elements may vary depending on application.

The roller parameters, light dose, frequency of use and the method of application identified herein can be varied (or configured) so as to cause optimal trauma to weeds.

The weed control device 400 generally operates in the furrows between the growing crop, similarly to commonly employed ploughs. The row spacing can be configured and used in such a way that the whole of fields can be treated irrespective of furrows being present.

The weed control device 400 can operate day or night and in a variety of weather conditions. The device 400 has the further effect of reducing the water required for crop production because herbicide is mixed with large quantities of water to facilitate herbicide spraying.

The weed control device 400 is able to be drawn manually by a vehicle such as a tractor, alternately it could form part of an autonomous vehicle.

Each of the weed stressor means is optional, variable and dependant on particular application although one uniform combination may end up providing a uniform commercial solution (e.g. Circumferential heating strips, heated or cooled; UV; chemical or gas dosed pneumatic air; circumferential glass segments; roller surface texture and material).

It will be possible for each of the variable parameters/equipment functions/light doses cited herein to be computer controlled with a vision system/sensors/control feedback loop connected to a computer system. The computer system could incorporate machine learning, artificial intelligence or a neural network to control the weed control device's 400 parameters in real time.

The weed control device 400 has application in other industries, for example, along roadways, along railways, in parks and in mine sites to mention a few.

The application period is not limited only to 6-12 hours, but can occur with the initial pass and then may re-occur as often or as necessary as desired including for example, perhaps weeks after the initial pass.

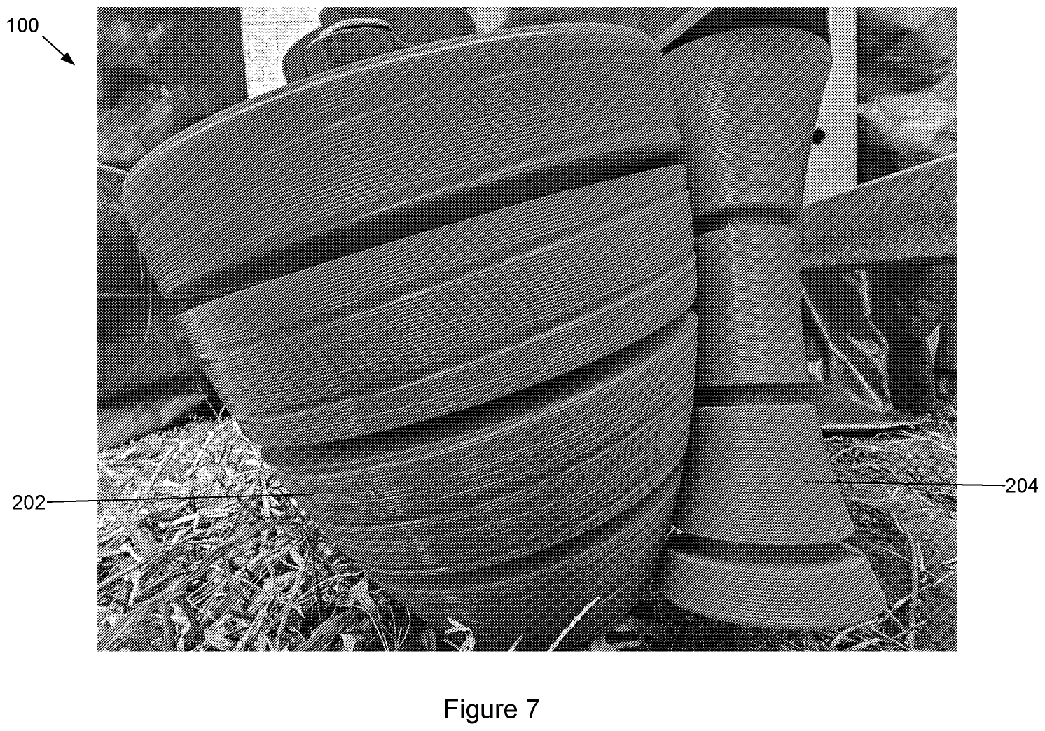

FIG. 7 shows that the surfaces 202, 204 may be ribbed, grooved or corrugated for improved weed damage.

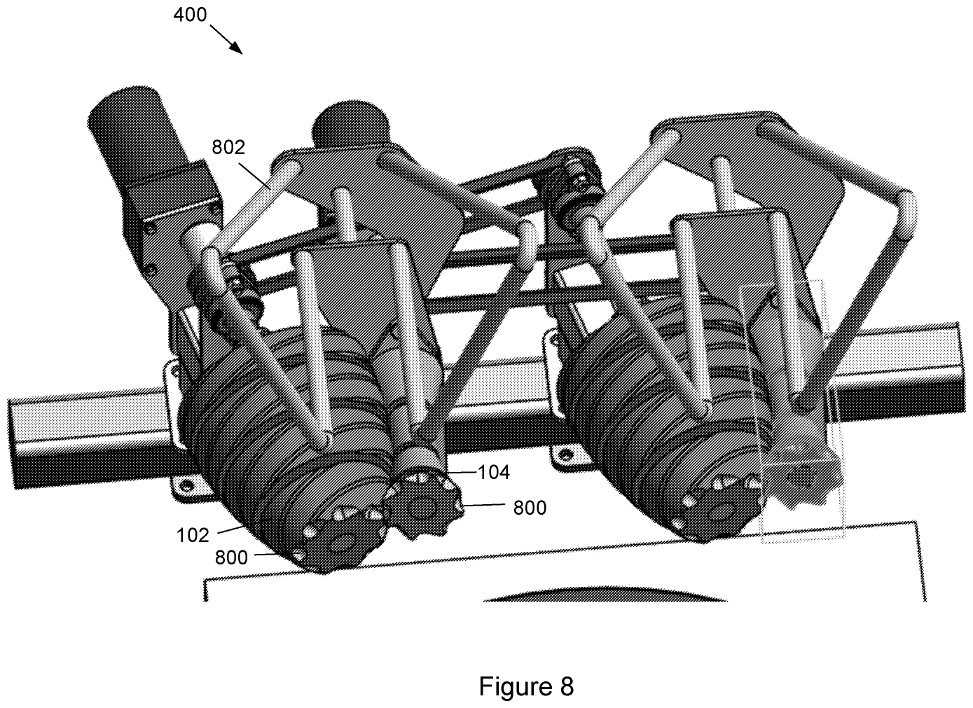

FIG. 8 shows scalloped profiles 800 at the base of the rollers 102, 104 for directing weeds to towards the convergence point of the rollers 102, 104. The device 400 also include tapering guide bars 802 for guiding the weeds into the rollers 102, 104.

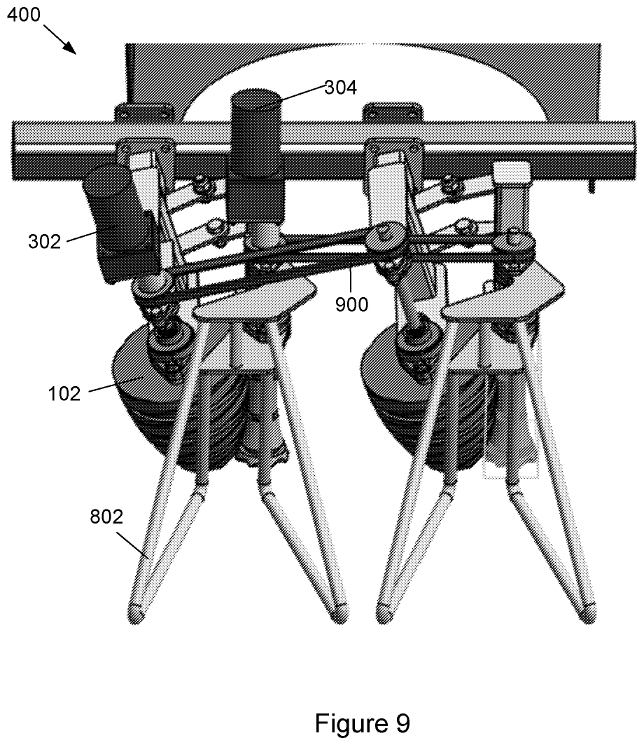

As can best be seen in FIG. 9, the device 400 includes a drive mechanism, using hybrid belt drives. As before, motors 302, 304 are provided for directly driving respective rollers 102, 104, although also drive other rollers via belts 900.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combination.

1. A weed control module including:
a first roller; and
a second roller for locating adjacent the first roller to cause damage to weeds passing between the rollers and/or under the rollers;
wherein the first roller includes a convex surface and the second roller includes a concave surface, the first and second rollers forming a complementary fit.

2. A weed control module as claimed in claim 1, wherein the weed control module is used to achieve weed control by stressing and maiming the weeds and in doing so, using the weeds as sacrificial vegetation that, secondary to their control through death or maiming, sacrificially assist the growth of planted crops.

3. A weed control module as claimed in claim 1, wherein the rollers have a curved interface, preferably configured to apply a vertical or pulling force to the weeds.

4. (canceled)

5. A weed control module as claimed in claim 1, wherein the weed control module includes motor means for driving the rollers in opposite directions to draw the weeds between them, the motor means preferably including belts for driving other rollers.

6. A weed control module as claimed in claim 5, wherein the rollers are driven at different speeds.

7. A weed control module as claimed in claim 1, wherein the rollers compress the weeds and are adjustable to adjustably control the degree of compression.

8. A weed control module as claimed in claim 1, wherein each roller rotates about a roller axis extending at an acute angle from vertical.

9. A weed control module as claimed in claim 1, wherein at least one of the rollers include a gripping surface for gripping the weeds, the gripping surface preferably being a ribbed, grooved or corrugated surface.

10. A weed control module as claimed in claim 1, wherein at least one of the rollers includes:
a heater for applying heat to the weeds;
one or more fluid passages through which pneumatic air, gas and/or chemicals can be supplied to the weeds;
slots in the form of deep slots and shallow slots;
helical formations, whether depressed or protruding;
weed contact picks on the underside face of the roller adjacent to the soil surface; and/or
scalloped or uneven formations at its base.

11. A weed control module as claimed in claim 1, further including:
guard means for guarding at least one of the rollers, the guard means preferably including a sheath;
one or more mounting brackets, and spindles extending from the rollers and through the mounting brackets;
guides for guiding weeds between the rollers;
a reflector for reflecting light;
a horizontal ground support roller; and/or
mechanical or electrical sensors that detect the height between ground features and the module.

12. A modular weed control device including one or more of the modules of claim 1.

13. A modular weed control device of claim 12, wherein the modules are arranged in sets.

14. A modular weed control device of claim 13, wherein each set is located in register with a respective furrow and/or between adjacent crop rows.

15. A modular weed control device of claim 13, wherein each set includes a quartet of modules, the quartet being symmetrically arranged with a pair of distal forward modules and a pair of proximal rearward modules.

16. A modular weed control device of claim 12, further including:
one or more light mounting frames to which lights are mounted;
a frame to which the modules are mounted;
an electrical power source for powering the device; and/or
a terrain following mechanism which automatically adjusts the height of the rollers as the weed control device passes over uneven terrain so that the distance between the rollers and terrain remains constant.

17. A modular weed control device of claim 12, further including a stressor applicator for applying a stressor to the weeds.

18. A modular weed control device of claim 17, wherein the stressor includes any one or more of a mechanical, light, thermal and pneumatic stressor.

19. A modular weed control device of claim 17, wherein the stressor applicator includes a light source for applying light, the light including ultra-violet (UV) light and even more preferably UV-C light.

20. A weed control method including:
passing weeds between a first roller and a second roller located adjacent to the first roller to cause damage to the weeds;
wherein the first roller includes a convex surface and the second roller includes a concave surface, the first and second rollers forming a complementary fit.

21. A weed control method of claim 20, achieving weed control without ploughing and without the application of herbicides, the method further involving applying a stressor to the weed and/or leaving the damaged weed in the ground to facilitate growth of a crop.

22. (canceled)

23. (canceled)

24. (canceled)

25. (canceled)
